(19) United States
(12) Patent Application Publication
(10) Pub. No.: US 2010/0074809 A1
(43) Pub. Date: Mar. 25, 2010

(54) PLASMA ENERGY CONVERTER AND AN ELECTROMAGNETIC REACTOR USED FOR PRODUCING SAID CONVERTER

(76) Inventor: Boris Fedorovich POLTORATSKY, Moscow (RU)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/522,678

(22) PCT Filed: Aug. 3, 2007
(86) PCT No.: PCT/RU07/00428

§ 371 Date: Jul. 9, 2009

(30) Foreign Application Priority Data
Feb. 12, 2007 (RU) 2007105087

(51) Int. Cl. H05H 1/02

(52) U.S. Cl. 422/186.04

(57) ABSTRACT

A plasma energy converter and an electromagnetic reactor used for producing said converter are claimed. The invention relates to methods and devices of plasma physics, in particular to systems used for the electromagnetically confining a high-energy plasma in such a way that the conditions for carrying out high-temperature reactions, including a controlled nuclear fusion reaction, are formed. The invention comprises a working chamber provided with a working medium which is placed in the field of an electromagnetic system for confining and heating a plasma. Said system consists of at least two electromagnetic vortex reactors having opposite charges and mutually oppositely oriented spins, the vortex fields of which are located in the working chamber. The reactors comprise a working chamber and a system for initiating the plasma state of the working medium. Said system for initiating the plasma state of the working medium comprises the concentrator of a microwave vortex electromagnetic field, the axis of which coincides with the axis of the reactor vortex field.

This invention relates to methods and apparatuses of plasma physics, in particular to systems designed for the electromagnetic confinement of high-energy plasma for creating conditions for carrying out high-temperature reactions, including a controlled nuclear fusion reaction. This invention may also be used for plasma separation of crude oil and for initiating other high-temperature reactions.

Confining high-temperature plasma is a key problem in controlled thermonuclear fusion. There are presently two confinement methods. The first method is inertial confinement, for example initiating a reaction with a laser (cf., for example, U.S. Pat. No. 6,418,177, Stauffer et al.; 9 Jul. 2002., Int. Cl.: HO5H 1/22, US Cl.: 376/152). The second method is confinement by a magnetic field (cf., for example, U.S. Pat. No. 6,664,740; Rostoker et al., 16 Dec. 2003, Int. Cl.: G21D 7/00, US Class 315/111.41). The problem with the first method is focusing a large amount of energy in a very small volume and the complex supply system for the working medium. The main problem in magnetic plasma confinement systems is suppressing the great number of instabilities. All the instabilities are gas-dynamic in origin and are related to the numerous types of oscillations in a magnetized plasma. Consequently, it is practically impossible to eliminate them entirely.

The closest prototype of the proposed technical solution is the device in accordance with U.S. Pat. No. 7,119,491 B2 of 10 Oct. 2006, Int. Cl. H01.J 7/24, U.S. Cl. 315/111.61. The known device has a working chamber with a working medium, placed in the field of the electromagnetic plasma confinement and heating system. It also contains a system for exciting the working medium to the plasma state in the working chamber. The main electromagnetic confinement and heating system comprises electromagnets, which form a pulsed, circular toroidal magnetic field with the addition of a helical component around the axis of the toroid.

The disadvantage of the known device is the limited stability of the plasma and the short fusion reaction time. These disadvantages are related to the gas-dynamic instability, which basically cannot be eliminated.

The object of the present invention is to increase the stability of the plasma and to lengthen the reaction time.

This object is achieved in that the electromagnetic plasma confinement and heating system of the plasma energy converter contains at least two electromagnetic vortex reactors with opposite charges and mutually oppositely oriented spins, the vortex fields of which are located in the working chamber.

The working chamber may be designed as a flow-through type having an inlet channel and an outlet channel connected via the external circuit, which contains a mechanical energy converter, a cooler, a receiver, and a compressor connected in series.

The working medium in the working chamber may contain a liquid phase.

The working medium in the working chamber may contain a solid phase.

The object is also achieved in that the plasma excitation system for the working medium in each electromagnetic vortex reactor contains a high-voltage concentrator for the electromagnetic microwave vortex field, the axis of which coincides with the axis of the vortex field of the reactor.

The concentrator of the electromagnetic microwave field may be made in the form of a waveguide ring resonator, which is connected to the working medium located near the axis of the vortex field in the reactor.

The electromagnetic vortex reactor may contain a system for transmitting an initial electrical charge to the area near the axis of the reactor's vortex field.

The electromagnetic vortex reactor may contain a system for preliminary ionization of the working medium near the axis of the reactor's vortex field.

The electromagnetic vortex reactor may contain a system for transmitting an initial magnetic moment to the region near the axis of the reactor's vortex field.

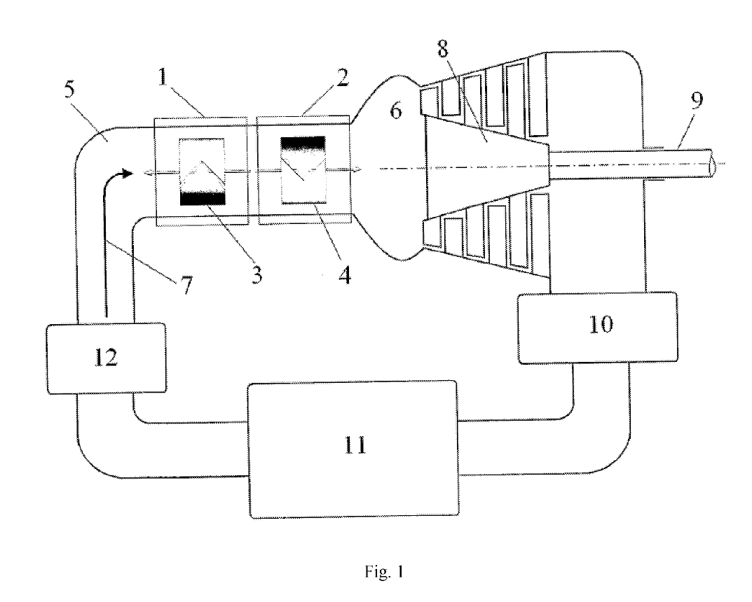

FIG. 1 shows a schematic diagram of the plasma energy converter.

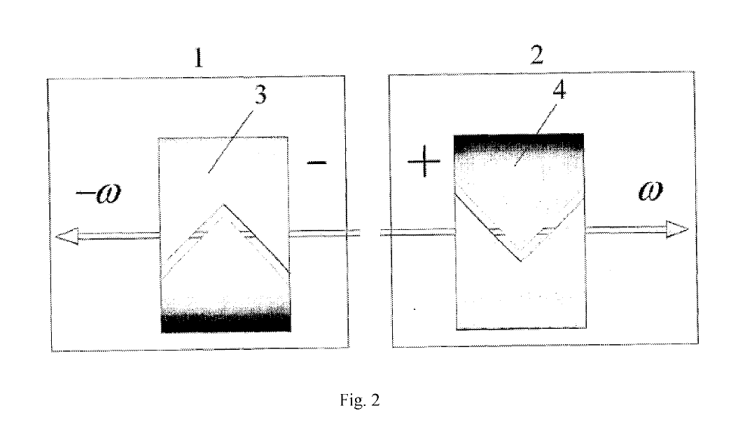

FIG. 2 shows the relative position of two electromagnetic vortex reactors with opposite charges and oppositely oriented spins.

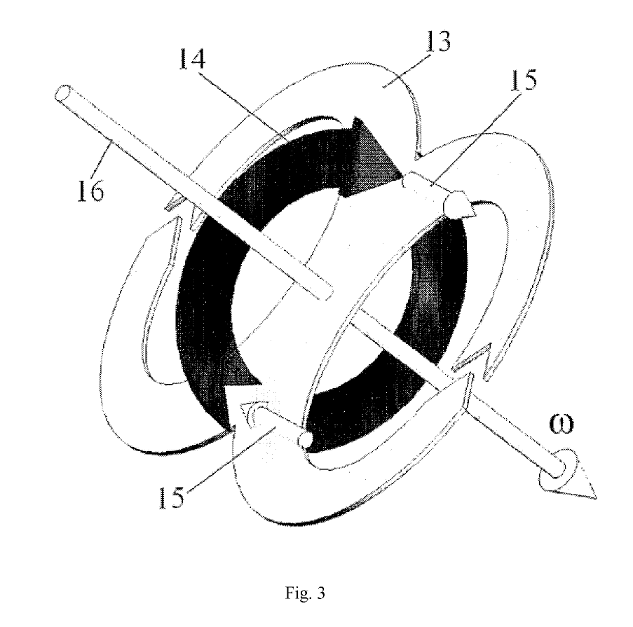

FIG. 3 shows the configuration of the electric and magnetic fields, as well as the Poynting vectors in one phase of the microwave field in the reactor.

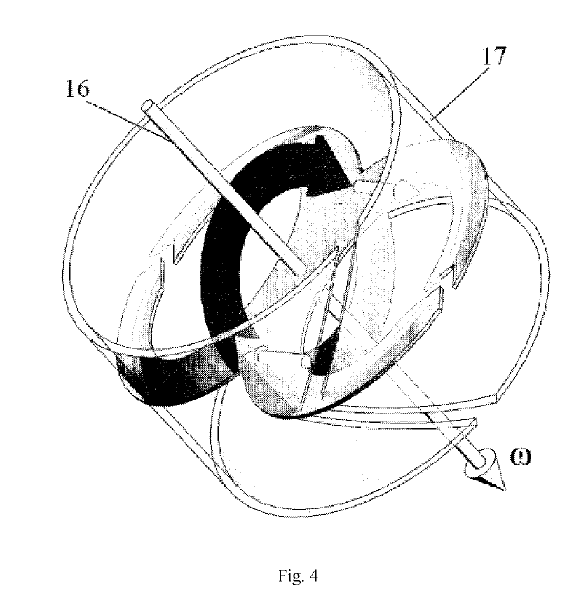

FIG. 4 shows the arrangement of the fields and the flow direction of the total energy.

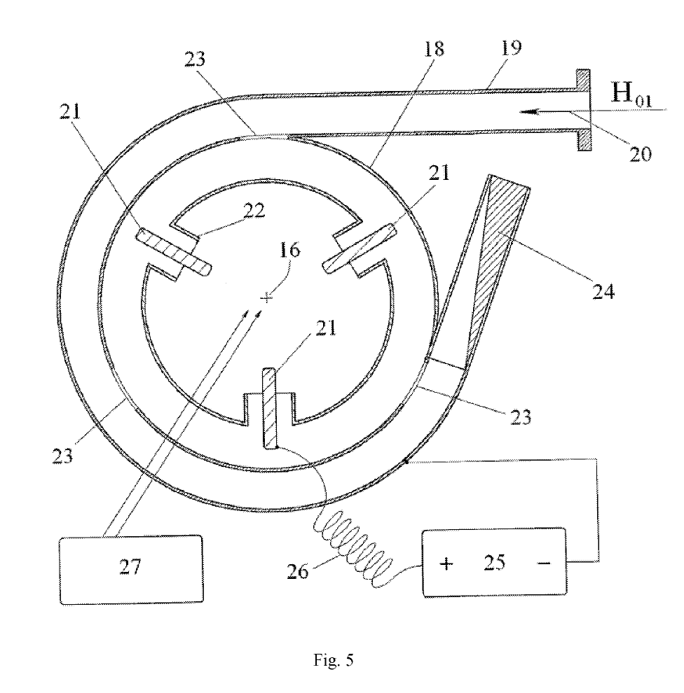

FIG. 5 shows a schematic diagram of an electromagnetic vortex reactor, with a concentrator of a microwave vortex electromagnetic field, shown in cross section.

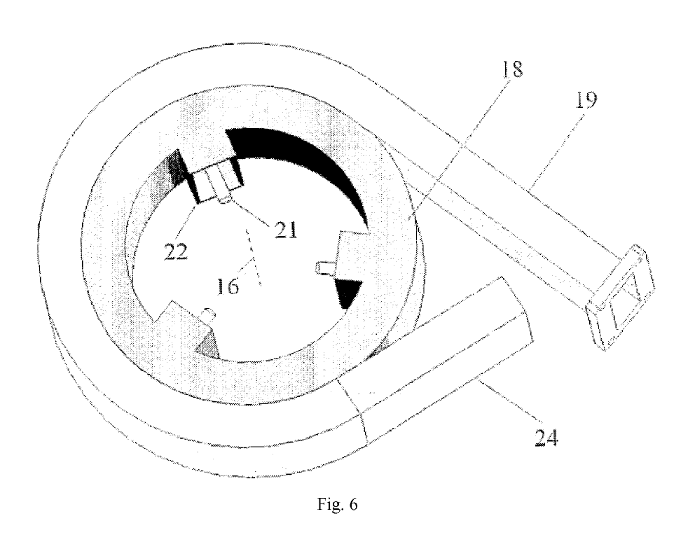

FIG. 6 shows an overall view of the waveguide portion of the electromagnetic vortex reactor.

The plasma energy converter, a schematic diagram of which is shown in FIG. 1, contains a first electromagnetic vortex reactor (1) and a second electromagnetic vortex reactor (2). Their vortex zones (3) and (4) are placed between the inlet channel (5) and the outlet channel (6). The working medium (7) fills the inlet channel (5). The outlet channel (6) is connected to the mechanical energy converter (8), which is provided with an output shaft (9). The outlet of the mechanical energy converter (8) is connected to the inlet channel (5) via the cooler (10), the receiver (11), and the compressor (12).

The relative position of the two electromagnetic vortex reactors (3) and (4), presented in FIG. 2, is characterized by opposite charges in their vortex zones (3) and (4) and by oppositely oriented directions of rotation, i.e. their spins.

The field configuration, shown schematically in FIG. 3, corresponds to one of the phases of a rotating variable electromagnetic vortex field. In it, the electric field (13) has the form of a dipole, arranged transverse to the vertical axis. The magnetic field (14) in this electromagnetic vortex has the form of a ring, arranged in the vertical plane. The vectors of the electric and magnetic fields are mutually perpendicular at their points of intersection. For this reason, the Poynting vectors (15) here are perpendicular to both fields and are oriented so as to create a mechanical moment with respect to their common axis, coinciding with the axis (16) of the reactor's vortex field.

The mean energy flux (17) of the vortex, shown in FIG. 4, is arranged with respect to the entire system of variable fields in such a way as to form a ring around the common axis (16) of the vortex field of the reactor.

The electromagnetic vortex reactor, a schematic diagram of which is shown in FIG. 5, contains a ring resonator (18), shown in cross section, which is arranged on the axis (16) of the reactor's vortex field. On the outside, the resonator (18) is connected to the input waveguide (19). A microwave (20) is propagated in the input waveguide. An example is presented here using a type H₀₁ wave. The ring resonator (18) contains elements connecting it with the space inside the ring, near the axis (16) of the reactor's vortex field. The electrical coupling is made via pins (21), while the magnetic coupling is via the open waveguides (22). The resonator (18) is connected to the input waveguide (19) via the coupling windows (23). The free end of the input waveguide is connected to the tuned load (24). Pins (21) are DC coupled to a DC voltage source (25) through a decoupler, in the form of an inductive element (26). The field from the ionizing radiation source (27) intersects the space of the ring resonator (17), located near the axis of the reactor's vortex field (16).

A general view of the waveguide section of the electromagnetic vortex reactor, shown in

FIG. 6, depicts the ring resonator (18), the inlet waveguide (19), and the tuned load (24), which are connected to one another. The ring resonator (18) is located on the axis (16) of the reactor's vortex field and has the outlet elements: pins (21) and open waveguides (22).

The proposed devices operate in the following manner.

In the initial state, the working zones near the axis of the electromagnetic vortex reactors (1) and (2) for plasma energy conversion are filled with cold working medium (7) (cf. FIG. 1). Its operation begins after the electromagnetic vortex reactors (1) and (2) are turned on, a schematic diagram of each reactor being shown in FIG. 5. This occurs after the microwave (20) enters the waveguide inlet (19) of each electromagnetic vortex reactor (1) and (2). At the same time, in each reactor the DC voltage source (25) and the ionizing radiation source (27) are turned on. The microwaves from the waveguides (19) enter the ring resonators (18) through coupling windows (23). Through the rods (21) and open waveguides (22), the microwave enters the regions of the axes (16) of the reactor vortex fields, where microwave rotating vortex electromagnetic fields are created. The inductive element (26) provides decoupling between the DC electric field and the alternating electric field. In the initial state, there are no high-frequency discharges in the vortex region of each reactor. Consequently, in this phase of the process the Q factor of the ring resonators (18) has its maximum value. As a result, the strength of the fields in the vortex region increases exponentially to the breakdown value. Breakdown sharply reduces the resistance of the load on the resonators. This, in turn, reduces their Q factor. Thus, the processes involved in each of the discharges are stabilized. As a result, electromagnetic vortexes are formed with the structure shown in FIGS. 3 and 4, which are also described in the work of Poltoratsky entitled, “Elektromagnitnyi vikhr' v strukture elementarnykh chastits” [The Electromagnetic Vortex in the Structure of Elementary Particles], Moscow, 2006.

The electromagnetic microwave vortexes that are formed are arranged relative to each other as shown in FIG. 2. Their charges are opposite in sign and their spins are oriented in opposite directions. For this reason, their relative position in space is unstable. After the vortexes are formed, their mutual-interaction phase begins. As a result of this interaction, they converge and destroy each other—they are annihilated. In the process, all the energy that had been accumulated in the resonators and electromagnetic vortexes is released in a small volume. The time of the annihilation process is much less than the period of one microwave. In other words, it is so brief that no gas-dynamic or hydrodynamic processes have time to develop. Consequently, they are unable to influence any of the pulse process. If the medium was initially in the liquid or solid state, then there is a hydraulic shock. All this creates extremely high pressures and temperatures in the zone of interaction between the vortexes. This briefly induces a high-temperature chemical or nuclear reaction.

The process described above is pulsed. The repetition rate of such pulses should be selected taking into account the minimum duration of the pause between pulses and the required average intensity of the process. The minimum duration of the pause is determined by the relaxation time of the system, which is linked to the hydrodynamics of the process and, consequently, has a value greater by several orders of magnitude than the time of the electromagnetic process in which the vortexes are formed. For this reason, the microwave sources can operate with pulses having a relatively long off-time, i.e. under mild conditions. This off-time and the average intensity of the process may be regulated, depending on the possibilities for extracting useful energy and on the cooling system. In principle, there is no limitation on the average operating time of the proposed devices.

Thus, the proposal combines the advantages of the inertial and magnetic methods of plasma confinement, while eliminating their disadvantages. This promotes an increase in the stability of the plasma and indefinite extension of the reaction time. Consequently, the proposal achieves the stated objective.

1. A plasma energy converter, having a working chamber with a working medium, placed in the field of an electromagnetic plasma heating and confinement system, characterized in that, in order to increase the stability of the plasma and to lengthen the reaction time, the electromagnetic plasma confinement and heating system contains at least two electromagnetic vortex reactors having opposite charges and mutually oppositely oriented spins, whose vortex fields are located in the working chamber.

2. The plasma energy converter according to claim 1, further characterized in that the working chamber is of the flow-through type, having an inlet channel and an outlet channel connected via the external circuit, which contains a mechanical energy converter, a cooler, a receiver, and a compressor, connected in series.

3. The plasma energy converter according to claim 1, further characterized in that the working medium has a liquid phase in the working chamber.

4. The plasma energy converter according to claim 1, further characterized in that the working medium has a solid phase in the working chamber.

5. An electromagnetic vortex reactor containing a working chamber and a system for exciting a plasma state in the working medium in said chamber, characterized in that, in order to increase the stability of the plasma and to extend the reaction time, the system for exciting a plasma state in the working medium contains a high-voltage concentrator for the electromagnetic microwave vortex field, the axis of which coincides with the axis of the vortex field of the reactor.

6. The electromagnetic vortex reactor according to claim 5, further characterized in that the concentrator of the rotating microwave electromagnetic field is made in the form of a waveguide ring resonator that is connected to the working medium, which is located near the axis of the vortex field of the reactor.

7. The electromagnetic vortex reactor according to claim 5, further characterized in that it contains a system for transmitting the initial electrical charge into the region of the axis of the reactor's vortex field.

8. The electromagnetic vortex reactor according to claim 5, further characterized in that it contains a system for preliminary ionization of the working medium in the region of the axis of the reactor's vortex field.

9. The electromagnetic vortex reactor according to claim 5, further characterized in that it contains a system for transmitting an initial magnetic moment into the region of the axis of the reactor's vortex field.
